(19) United States
(12) Patent Application Publication
(10) Pub. No.: US 2021/0091541 A1
(43) Pub. Date: Mar. 25, 2021

(54) A SWITCHING DEVICE

(71) Applicant: THE SECRETARY OF STATE FOR DEFENCE, LONDON (GB)

(72) Inventors: MATTHEW ADRIAN BROWN, READING (GB); JAMES PAUL HIEATT, READING (GB)

(21) Appl. No.: 16/971,773

(22) PCT Filed: Feb. 28, 2019
(86) PCT No.: PCT/GB2019/000036

§ 371 Date: Aug. 21, 2020

(30) Foreign Application Priority Data
Mar. 1, 2018 (GB) 1803338.1

(51) Int. Cl. H01T 2/02; H01T 21/02

(52) U.S. Cl. CPC H01T 2/02; H01T 21/02

(57) ABSTRACT

A Triggered Gap includes a cathode (4) that is positioned between a reservoir (8) for example a carbon reservoir, and an anode (3). The cathode (4) has an aperture (11) that allows material from the reservoir (8) to ablate into a vacuum gap between the anode (3) and the cathode (4), thus closing the switch.

This invention relates to general medium voltage and high voltage switching devices.

It is well known that Triggered Vacuum Gaps (TVGs) comprise an anode, a cathode, a trigger electrode and a reservoir. Prevalent designs are geometrically configured with the trigger electrode, reservoir and cathode in an orthogonal arrangement to the aligned cathode and anode electrodes. TVGs (and gas filled variants) are utilized as multi-shot devices, with device shot lifetimes dependent on characteristics of individual tube designs, and the characteristics of the discharge circuits.

TVGs (and the gas filled variants) consist of three conductive surfaces with the main anode and cathode separated by a vacuum (or gas) gap, across which a dc medium or high voltage potential difference is applied. Between the trigger electrode and the cathode, a reservoir is located, typically consisting of carbon, which has ablative and non-linear dielectric/conductive properties. When the device is required to operate, a transient electrical pulse is applied to the trigger electrode. This transient electrical pulse between the trigger electrode and cathode results in a discharge arc that ablates and ionises the carbon, which under the influence of the geometrically controlled electrical field bridges the gap between the anode and cathode, allowing the switch to operate.

The TVGs (and gas filled variants) are medium or high-voltage switches for applications where a wide operating voltage range is required. Switching times, defined as the time from the trigger input to the start of main gap current flow, of less than 1 microsecond may be achieved when using a suitably configured trigger.

Work has been undertaken on the design and development of TVGs since the 1950's, and have evolved over the decades. Patents RU2559027, KR20100047909, U.S. Pat. Nos. 4,126,808, 3,394,281, and 3,331,988 all disclose TVG switch designs that are based on orthogonal trigger arrangements with highly complicated assembly processes.

There are two crucial operating characteristics for high end performance TVGs: radiation hardness and timing. TVGs are, for example, inherently radiation hard due to the lack of any ionisable gas, and due to the choice of ceramic and metallic parts. Design optimization can reduce the trigger to anode delay (TAD) and jitter to levels required for high end applications. TVGs thus require complicated design of the trigger arrangement and are expensive to manufacture.

It is therefore an object of the present invention to provide a Triggered Gap with a design that is less complicated and less expensive to manufacture, whilst still maintaining radiation hardness and optimization and control of timing.

This object is achieved by the Triggered Gap according to Claim 1 in which a cathode is positioned between a reservoir and an anode and the cathode has an aperture for allowing material from the reservoir to ablate into a vacuum gap. Under the influence of the internal electric field, the plasma generated from ablation of the material from the reservoir closes the switch between the anode and the cathode.

The invention has the advantage that the trigger arrangement aligns with the compression axis during brazing operations, allowing improved control and ensuring that no unwanted gaps exist once brazing material has melted and flowed. This constrains the impedance of the trigger arrangement which in turn determines the ‘switch on’ characteristic of the device. It also allows for tolerance stack-up associated with differential thermal expansion and contraction coefficients and braze flow during braze operations. Additionally, this arrangement removes the requirement for complicated sub-assembly operations, and assembly of the invention is by stacking the piece parts as a single operation prior to brazing.

The trigger electrode is designed with a flat surface to provide a function in addition to ease of manufacture. The choice of metal is critical with regard to shot life and preferred material tends to have high melting points to inhibit electrode ablation and erosion of critical electrical field characteristics. A flat surface provides a known surface configuration with regard to control of the electrical field (i.e. not subject to shot life drift). A flat surface is also considerably easier to manufacture rather than relying on controlled radii of curvature (or sharp corners) to control critical field configuration. It is well known that sharp corners, if critical discharge points, are susceptible to electrode erosion/ablation for successive shots. The significant geometric advantage of the flat surface in the construction is that the field configuration (vector) enhances the driving electrical field which controls the ionised plasma emanating from the reservoir thereby enhancing acceleration of the plasma into the cathode/anode region.

The invention provides the same functionality as other Triggered Gap type switching devices, however this design has the advantage that it can overcome significant manufacturing and cost implications and difficulties regarding device design, processes and assembly operations, which are typical of radial trigger arrangements.

An embodiment of the invention will now be described by way of example with reference to the accompanying drawings, in which:

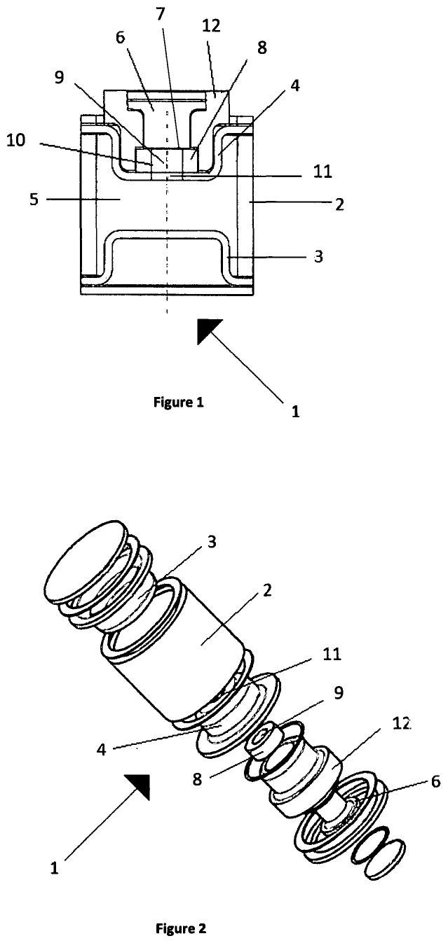

FIG. 1 is a transverse view of the an axially symmetric Triggered Gap after brazing; and

FIG. 2 is an exploded view of the Triggered Gap assembly.

Referring to FIG. 1, a Triggered Gap (1) has a body (2), manufactured from alumina, that provides a protective envelope to encase an anode (3) and a cathode (4), both of which are manufactured from niobium. This enables the main gap (5) to be held at vacuum (rarified atmosphere). A trigger electrode (6), with a flat surface (7), also manufactured from niobium, is in contact with a reservoir (8) of ablative material, for example carbon, that has an aperture (9) through it. This arrangement enables a trigger pulse to be applied to the Triggered Gap (1) via the trigger electrode (6), causing material, in this case carbon, from the surface (10) of the reservoir (8) to ablate into the main gap (5) forming a plasma during operation (not shown). This plasma is able reach the main gap (5) by virtue of an aperture (11) through the cathode (4). The formation of this plasma effectively bridges the main gap (5) between the anode (3) and the cathode (4) thus closing the switch. The physical masking and electrical field configuration controlled via the geometry also minimize deposition of the ablated material onto the walls of the main body ceramic, thereby extending usable shot life.

The reservoir (8) additionally provides the important non-linear and controlled impedance/conductive characteristic necessary for the controlled triggering of the Triggered Gap (1). The reservoir (8) can comprise materials other than carbon, for example the carbon could be substituted by a multi-laminar array to tune the impedance characteristics for the desired trigger input, without alteration of the other component parts of the Triggered Gap (1). An alternative to carbon could, for example, be a ceramic coated with thin metallic coatings or carbon.

A trigger ceramic (12) provides electrical isolation between the trigger electrode (6) and the cathode (4). The trigger ceramic (12) also holds the Triggered Gap assembly in place.

The anode (3), the cathode (4) and the trigger electrode (6) may be manufactured from materials other than niobium, for example tungsten, tantalum, copper, molybdenum or Kovar®. The body (2) need not be made from alumina, but could, for example, be manufactured from another ceramic material, or sapphire.

Furthermore, it should be noted that whilst the aperture (9) through the carbon reservoir (8) is preferable as it enables the carbon reservoir (8) to be positioned between the trigger electrode (6) and the cathode (4), a Triggered Gap according to claim 1 could operate without the aperture (9), for example if the Triggered Gap were no longer axially symmetric.

FIG. 2 shows an exploded view of the Triggered Gap (1) that clearly shows that the anode (3), the cathode (4) and the carbon reservoir (8) are positioned on a single axis. It is this single axis that enables the compression of the Triggered Gap (1) during the brazing stage of the manufacturing process.

The Triggered Gap of this embodiment of the invention thus provides a simple design allowing for easier assembly and manufacture with the additional advantage of being easily adaptable to operate at different voltage levels, with greatly increased shot life as a result of a larger carbon reservoir.

Whilst this embodiment is for a Triggered Gap that could be a TVG because it includes a main gap (5) that can be held at a vacuum, the design would work for a Triggered Gap where the main gap (5) contains an ionisable gas. This would result in the Triggered Gap no longer being radiation-hardened, but it would still operate effectively as a switch.

Modifications and improvements may be made without departing from the scope of the invention.

1. A Triggered Gap characterized in that a cathode is positioned between a reservoir and an anode and the cathode has an aperture for allowing material from the reservoir to ablate into a gap.

2. The Triggered Gap according to claim 1, characterized in that the gap is a vacuum gap.

3. The Triggered Gap according to claim 1, characterized in that the gap contains a gas.

4. The Triggered Gap according to claim 1, characterized in that the anode, cathode and reservoir are aligned along a single axis.

5. The Triggered Gap according to claim 1, characterized in that the reservoir has an aperture the reservoir is positioned between a trigger electrode and the cathode.

6. The Triggered Gap according to claim 5, characterised in that the trigger electrode, anode, cathode and reservoir are aligned along a single axis.

7. The Triggered Gap according to claim 6, characterised in that the trigger electrode has a flat surface adjacent to the aperture and substantially perpendicular to the single axis.

8. The Triggered Gap according to claim 1, in which the anode the cathode and the trigger electrode comprise niobium, tungsten, tantalum, copper, molybdenum or Kovar.

9. The Triggered Gap according to claim 1, in which the reservoir comprises carbon.

10. The Triggered Gap according to claim 1 in which the reservoir comprises a multi-laminar array.

11. The Triggered Gap according to claim 1, in which a body comprises alumina or sapphire.
